(19) United States
(12) Patent Application Publication
(10) Pub. No.: US 2016/0378757 A1
(43) Pub. Date: Dec. 29, 2016

(54) CONCEPT IDENTIFIER RECOMMENDATION SYSTEM

(71) Applicant: Facebook, Inc., Menlo Park, CA (US)

(72) Inventor: Amit Bahl, Pleasanton, CA (US)

(21) Appl. No.: 14/747,917

(22) Filed: Jun. 23, 2015

(51) Int. Cl. G06F 17/30; G06N 5/04; G06N 99/00

(52) U.S. Cl. CPC G06F 17/3053; G06F 17/30867; G06F 17/30554; G06N 99/005; G06N 5/04

(57) ABSTRACT

Some embodiments include a method of defining a concept taxonomy. The concept taxonomy can be a mechanism to identify user activities that is relevant to a content analysis study. For example, the method can include identify one or more explicit concept identifiers to include in a concept taxonomy on a user interface. The method can include generating a relevant concepts network by identifying one or more potential concept candidates in past user activities within a time window. The relevant concepts network can include the potential concept candidates and the explicit concept identifiers as nodes. A concept taxonomy system can then select at least a subset of the potential concept candidates to present on the user interface as concept recommendations to supplement the concept taxonomy by identifying commonalities between the nodes of the relevant concepts network.

### BACKGROUND

Machine intelligence may be useful to gain insights to a large quantity of data that may appear incomprehensible to human comprehension. Machine intelligence, also known as artificial intelligence, can encompass machine learning analysis, natural language parsing and processing, computational perception, or any combination thereof. These technical means can facilitate studies and researches yielding specialized insights that are normally not attainable by human mental exercises.

For example, various natural language processing and analyses can be performed on activities of a social networking system to generate insights associated with human interactions. Such natural language processing and analyses consume large amount of computational resources. When the amount of data that is analyzed increases, real-time or near real-time insights become challenging to produce. Yet the more data that is analyzed, the clearer the generated insights would be. A preset filter may be used to reduce input data and thus decrease the amount of data to analyze. However, the preset taxonomy may become outdated quickly and may not be sophisticated enough to capture all relevant activities that may affect decisions of the machine intelligence.

### BRIEF DESCRIPTION OF THE DRAWINGS

FIG. 1 is a block diagram illustrating an application service system implementing a concept study system, in accordance with various embodiments.

FIG. 2 is a block diagram illustrating a concept taxonomy system, in accordance with various embodiments.

FIG. 3 is an example screenshot of a definition interface for defining a concept taxonomy, in accordance with various embodiments.

FIG. 4 is an illustration of an example of a relevant concepts network, in accordance with various embodiments.

FIG. 5A is an example illustration of a portion of a relevant concepts network used to determine one or more concept recommendations, in accordance with various embodiments.

FIG. 5B is another example illustration of a portion of a relevant concepts network to determine one or more concept recommendations, in accordance with various embodiments.

FIG. 6A is an example illustration showing how a co-visitation commonality is established between two concept identifiers, in accordance with various embodiments.

FIG. 6B is an example illustration showing how a co-approval commonality is established between two concept identifiers, in accordance with various embodiments.

FIG. 6C is an example illustration showing how a co-occurrence commonality is established between two concept identifiers in a social network page, in accordance with various embodiments.

FIG. 6D is an example illustration showing how a co-occurrence commonality is established between two concept identifiers in a status update, in accordance with various embodiments.

FIG. 7 is a flow chart illustrating a method of operating a concept study system, in accordance with various embodiments.

FIG. 8 is a flow chart illustrating a method of operating a concept taxonomy system, in accordance with various embodiments.

FIG. 9 is a high-level block diagram of a system environment suitable for a social networking system, in accordance with various embodiments.

FIG. 10 is a block diagram of an example of a computing device, which may represent one or more computing device or server described herein, in accordance with various embodiments.

FIG. 11 is a flow chart illustrating a method of generating a relevant concepts network for a concept taxonomy, in accordance with various embodiments.

The figures illustrate various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

Several embodiments are directed to a concept taxonomy system that creates and manages a flexible taxonomy of concepts (together referred to as a “concept taxonomy”). The concept taxonomy system can be part of or coupled to a concept study system that enables analyzing and studying of user activities pertaining to a concept taxonomy from an application service system or a social networking system. The concept taxonomy system advantageously generates relevant concept identifier recommendations dynamically by analyzing previous user activities (e.g., in a social graph of a social networking system). For example, the concept taxonomy system can generate the relevant concept identifier recommendations “dynamically” by displaying one or more concept identifier recommendations on a user interface whenever an operating user inputs a new explicit concept identifier via the user interface. This enables the concept taxonomy system to incorporate relevant concept identifiers into a concept taxonomy without relying solely on user-entered taxonomy that may be too limiting or too stale.

A concept taxonomy can used by the concept study system to identify a subset of activities within an application service system (e.g., a social networking system) for analysis (e.g., real-time or delayed analysis). The concept study system can identify and analyze digital “chatter” around a central theme represented by a concept taxonomy and its associated concept taxonomy. Digital chatter is user-generated content submitted to the application service system, including for example, status updates, posts, comments, other forms of publications or conversations, or any combination thereof.

A user interface of the concept taxonomy system can generate a concept taxonomy by identifying one or more concept identifiers to associate with the concept taxonomy. The set of concept identifiers for the concept taxonomy can also be referred to as a topic taxonomy. A concept identifier, for example, can be a hash tag, an explicit or inferred topic tag, or a term object. An analyst user can seed the concept taxonomy with one or more explicit concept identifiers. Concept identifiers are ways of identifying content (e.g., user-generated digital chatter) as being related to a central theme. Then, a recommendation engine of the concept taxonomy system can analyze past user activities (e.g., within a social graph of the social networking system) to build a relevant concepts network that represent a pool of potential concept identifiers. From the relevant concepts network, the recommendation engine can rank and pick concept identifier recommendations to present on the user interface.

Concept identifiers used to build a concept taxonomy can include, for example, topic tags, hashtags, and/or terms. User-generated content can be associated with a topic tag based on a topic inference engine or based on user indication (e.g., an explicit mention in a post or a status update. A topic tag, for example, can be represented as a social network page. A hashtag is a word that may be found within user-generated content denoting an authoring user's own intention for the content to be part of a topic or theme. A hashtag can have a known prefix or suffix (e.g., typically a prefix of the pound symbol “#”). A hashtag can be represented as a social network object. A term can be a text string comprised of two or more consecutive words. The concept taxonomy can determine that user-generated content maps to a term by scanning for the consecutive words in the user-generated content.

Based on the explicit concept identifiers, the definition engine can suggest additional concept identifier recommendations that have a high “commonality score” (e.g., based on co-occurrence scores, co-visitation scores, co-tagging scores, and/or co-liking scores) relative to the explicit concept identifiers. For example, a recommendation engine generates the concept identifier recommendations by first generating a relevant concepts network based on the explicit concept identifiers. The relevant concepts network can comprise explicit nodes corresponding to the explicit concept identifiers. The relevant concepts network can also comprise other potential candidate nodes. These potential candidate nodes can be sourced from past user activities within a time window (e.g., previous 7 days or 28 days). The potential candidate nodes and the explicit nodes can be connected to each other whenever two nodes share a commonality (e.g., co-occurrence in the same unit of content (e.g., a social network object or a content page on a system external to the application service system or the social networking system), or co-visitation, co-tagging, or co-approval by the same user). Each connection between two nodes can have an edge weight based on the frequency of the commonality within the past user activities in the time window. In some embodiments, the relevant concepts network can limit its size by having only potential candidate nodes within a preset degree of separation from the explicit nodes. In some embodiments, a visualization engine can render an illustration of the relevant concepts node.

Then, the recommendation engine can rank a potential candidate node based on how close the potential candidate node is to all of the explicit nodes or on how close the potential candidate node is to any of the explicit nodes. For example, the ranking can optimize for equal closeness to all of the explicit nodes, maximum closeness to all of the explicit nodes, or maximum closeness to any single explicit node. Here, closeness can be measured by the edge weight. The recommendation engine can suggest one or more of the potential candidate nodes as concept identifier recommendations based on the rankings of the suggested candidate nodes. An analyst user can explicitly confirm a concept identifier recommendation via the user interface. Once confirmed, the concept identifier recommendation is incorporated as part of the concept taxonomy and becomes an explicit concept identifier.

Concept identification within arbitrary user-generated content can be performed by upfront enumeration of all possible concept identifiers corresponding to a conceptual theme. This is a laborious task. This task is made more challenging by large gaps in knowledge within evolving concept taxonomies. A concept identifier recommendation system that can construct and manage timely and flexible global concept taxonomies can provide automated recommendations to accelerate and improve this enumeration process. The recommendation system can be part of or coupled to a concept study system that enables analyzing and studying of aggregated user activities on an application service system or a social networking system.

The recommendation system generates relevant concept identifier suggestions dynamically by continuously analyzing historical aggregated user activities. These activities consist of all user-generated content submitted to the application service system, including status updates, posts, comments, and other forms of publications or conversations (or any combination thereof). Such content is algorithmically mined for concept relationships based on content tagging via machine learning models (e.g., topic inference engines), user indicated metadata tags (e.g., an explicit mention or hashtag in a post or a status update), user actions (e.g., likes), or the presence of an arbitrary text term.

These learned concept relationships can be represented as networks of concept identifiers (e.g., topic identifiers, hashtags, terms, mentions, photo tags, etc.) that define the current conversation structure on the application service system. The querying of the resulting network representations via graph algorithms provides hierarchical insights into ongoing conversations and powers automated concept identifier recommendations. This enables the system to provide timely and relevant concept identifiers without relying solely on user-entered taxonomies that may be too limiting or stale.

A user interface of the recommendation system can generate a ranked list response to input concept identifiers and a specification of the mode of searching the backing networks. For example, an analyst user can seed the recommendation engine with one or more explicit concept identifiers. From the relevant concepts network, the recommendation engine can rank and pick concept identifier recommendations to present on the user interface. For example, the recommendation engine can rank a potential candidate node based on its distance (defined by edge weight learned in the previous step) to any subset of the input nodes. The ranking can be optimized in a fit for purpose manner for diverse applications requiring some combination of maximum closeness to all inputs, maximum closeness to any input, and greatest distance from select inputs (or any combination of these to arbitrary subsets of inputs). Once the user accepts a recommendation, the concept identifier recommendation is incorporated as part of the input seed in subsequent calls to the recommendation system. The final collection of concept identifiers can be saved, edited, and used in a variety of downstream applications such as concept study systems.

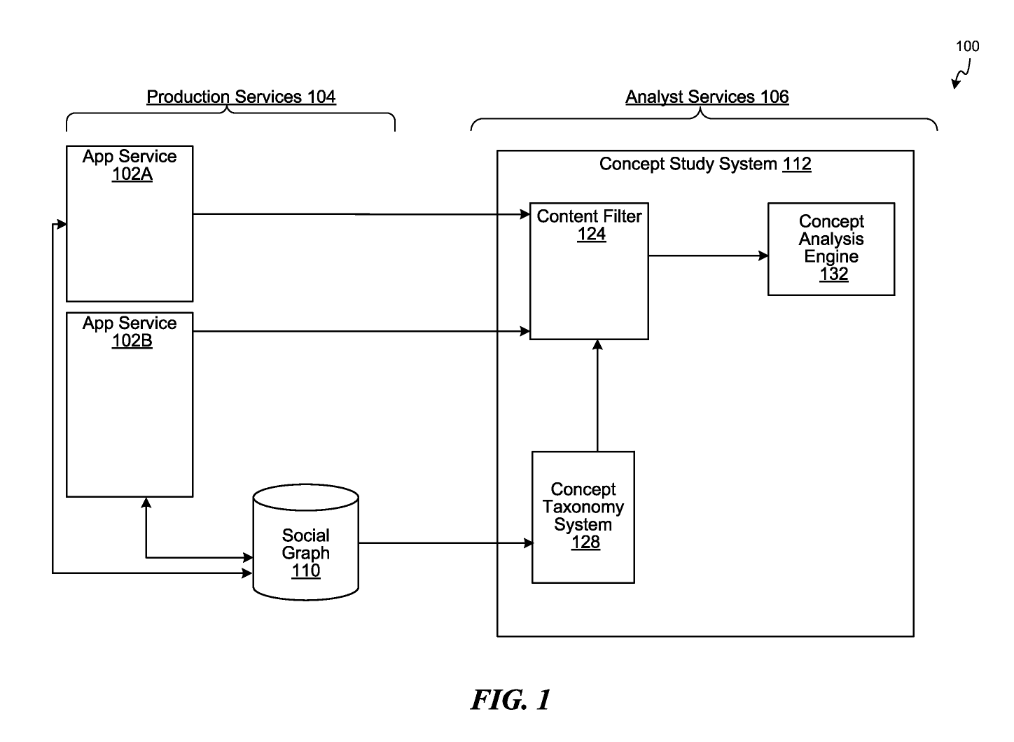

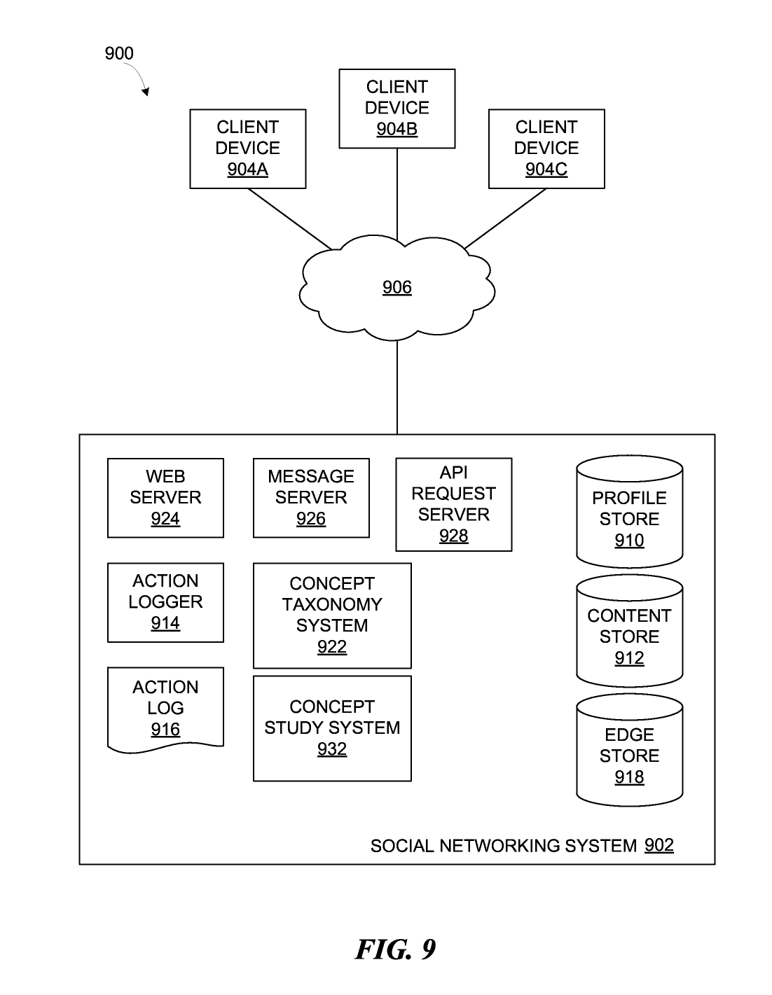

Referring now to the figures, FIG. 1 is a block diagram illustrating an application service system 100 implementing a concept study system 112, in accordance with various embodiments. The application service system 100 provides one or more application services (e.g., an application service 102A and an application service 102B, collectively as the “application services 102”) to client devices over one or more networks (e.g., a local area network and/or a wide area network). The application service system 100 can provide the application services 102 via an application programming interface (API), a Web server, a mobile service server (e.g., a server that communicates with client applications running on mobile devices), or any combination thereof. In some embodiments, the application service system 100 can be a social networking system (e.g., the social networking system 902 of FIG. 9). The application services 102 can process client requests in real-time. The client requests can be considered “live traffic.” For example, the application services 102 can include a search engine, a photo editing tool, a location-based tool, an advertisement platform, a media service, an interactive content service, a messaging service, a social networking service, or any combination thereof.

The application service system 100 can include one or more production services 104 that are exposed to the client devices, directly or indirectly, and one or more analyst services 106. In some embodiments, the analyst services 106 are not exposed to the client devices. In some embodiments, the analyst services 106 can be exposed a limited subset of the client devices. In some cases, the analyst services 106 can be used by operators of the application service system 100 to gain insights based on activities of the production services 104 (e.g., in real-time or asynchronously relative to the activities). In some cases, the analyst services 106 can be used to monitor, maintain, or improve the application services 102. In one example, at least one of the production services 104 can directly communicate with the client devices and respond to client requests from the client devices. In another example, a first outfacing production service can indirectly provide its service to the client devices by servicing a second outfacing production service. The second outfacing production service, in turn, can either directly provide its service to the client devices or provide its service to a third outfacing production service that directly provides its service to the client devices. That is, the production services 104 may be chained when providing their services to the client devices.

The application service system 100 includes the concept study system 112. The concept study system 112 can be one of the analyst services 106. The concept study system 112 can monitor and analyze user activities with the application services 102 to generate insights. The insights can be generated in real-time, substantially real-time, or asynchronous relative to the user activities.

For example, real-time user activities (e.g., user-initiated services requests and responses) can be forwarded to the concept study system 112 for processing. For example, real-time user activities can be recorded by the action logger 914 of FIG. 9. Past user activities can be recorded in a social graph 110. For example, the social graph 110 can be stored in the edge store 918 of FIG. 9.

The real-time user activities can be forwarded to a content filter engine 124. The content filter engine 124 can determine whether or not a particular user activity pertains to a “concept study.” A concept study, or a content analysis study, is a way to utilize machine intelligence to compute insights pertaining to user activities related to a central concept by analyzing content generated in the application service system 100. The concept study system 112 can utilize one or more “concept taxonomies” to determine whether a user activity relates to a central concept. In some embodiments, a single concept study can have multiple concept taxonomies. In some embodiments, a single concept study can have only a single concept taxonomy. These concept taxonomies can be defined by a concept taxonomy system 128. The concept taxonomy system 128 facilitates generation of a concept taxonomy that serves as a gatekeeper to determine whether a particular user activity is to be aggregated for analysis by a concept analysis engine 132.

In some embodiments, a concept taxonomy can explicitly define a list of text or multimedia filters that identify content of a user activity as pertaining to the central concept/theme. The explicitly defined filters can be represented as “explicit concept identifiers.” Because a central concept can be amorphous and evolving, the concept taxonomy system 128 can facilitate adding inferred qualities of content that may be relevant to the central concept. This enables the concept taxonomy system 128 to suggest concept identifier recommendations to an analyst user, enabling the concept taxonomy to be expanded to incorporate concepts that are not obvious to a human being, but may be relevant nonetheless.

The concept taxonomy system 128 can determine relevant concepts from the past user activities represented by the social graph 110 or a computer system external to the application service system 100 (e.g., via an API). For example, the concept taxonomy system 128 can generate a relevant concepts network based on the past user activities during a time window. At least some nodes in the relevant concepts network can represent potential concept candidates. Edges in the relevant concepts network can represent a degree of commonality between nodes.

The concept taxonomy system 128 can recommend and rank the nodes that may share some amount of “commonality” with the explicitly concept nodes. Commonality, for example, can include a relevant concept node co-occurring in a user-generated content (e.g., a post, a page, a status update, etc.) with another concept node (e.g., one of the explicitly defined concept nodes or another potential concept candidate). Another example, commonality can include content associated with a concept node being “liked” (e.g., a user indication of positive association or approval in a social networking system) by the same user who “liked” content associated with another concept node. In yet another example, commonality can include a unit of content associated with a concept node being visited by the same user who visited another unit of content associated with another concept node.

In several embodiments, the user activities that feed into the content filter engine 124 can come from the application service system 100 and/or a computer system external to the application service system 100. In several embodiments, the past user activities used by the concept taxonomy system 128 to suggest concept recommendations can come from the application service system 100 and/or a computer system external to the application service system 100.

### Social Networking System Overview

Several embodiments of the application service system 100 utilize or are part of a social networking system. Social networking systems commonly provide mechanisms enabling users to interact with objects and other users both within and external to the context of the social networking system. A social networking system user may be an individual or any other entity, e.g., a business or other non-person entity. The social networking system may utilize a web-based interface or a mobile interface comprising a series of inter-connected pages displaying and enabling users to interact with social networking system objects and information. For example, a social networking system may display a page for each social networking system user comprising objects and information entered by or related to the social networking system user (e.g., the user's “profile”).

Social networking systems may also have pages containing pictures or videos, dedicated to concepts, dedicated to users with similar interests (“groups”), or containing communications or social networking system activity to, from or by other users. Social networking system pages may contain links to other social networking system pages, and may include additional capabilities, e.g., search, real-time communication, content-item uploading, purchasing, advertising, and any other web-based inference engine or ability. It should be noted that a social networking system interface may be accessible from a web browser or a non-web browser application, e.g., a dedicated social networking system application executing on a mobile computing device or other computing device. Accordingly, “page” as used herein may be a web page, an application interface or display, a widget displayed over a web page or application, a box or other graphical interface, an overlay window on another page (whether within or outside the context of a social networking system), or a web page external to the social networking system with a social networking system plug in or integration capabilities.

As discussed above, a social graph can include a set of nodes (representing social networking system objects, also known as social objects) interconnected by edges (representing interactions, activity, or relatedness). A social networking system object may be a social networking system user, nonperson entity, content item, group, social networking system page, location, application, subject, concept or other social networking system object, e.g., a movie, a band, or a book. Content items can include anything that a social networking system user or other object may create, upload, edit, or interact with, e.g., messages, queued messages (e.g., email), text and SMS (short message service) messages, comment messages, messages sent using any other suitable messaging technique, an HTTP link, HTML files, images, videos, audio clips, documents, document edits, calendar entries or events, and other computer-related files. Subjects and concepts, in the context of a social graph, comprise nodes that represent any person, place, thing, or idea.

A social networking system may enable a user to enter and display information related to the user's interests, education and work experience, contact information, demographic information, and other biographical information in the user's profile page. Each school, employer, interest (for example, music, books, movies, television shows, games, political views, philosophy, religion, groups, or fan pages), geographical location, network, or any other information contained in a profile page may be represented by a node in the social graph. A social networking system may enable a user to upload or create pictures, videos, documents, songs, or other content items, and may enable a user to create and schedule events. Content items and events may be represented by nodes in the social graph.

A social networking system may provide various means to interact with nonperson objects within the social networking system. For example, a user may form or join groups, or become a fan of a fan page within the social networking system. In addition, a user may create, download, view, upload, link to, tag, edit, or play a social networking system object. A user may interact with social networking system objects outside of the context of the social networking system. For example, an article on a news web site might have a “like” button that users can click. In each of these instances, the interaction between the user and the object may be represented by an edge in the social graph connecting the node of the user to the node of the object. A user may use location detection functionality (such as a GPS receiver on a mobile device) to “check in” to a particular location, and an edge may connect the user's node with the location's node in the social graph.

A social networking system may provide a variety of communication channels to users. For example, a social networking system may enable a user to email, instant message, or text/SMS message, one or more other users; may enable a user to post a message to the user's wall or profile or another user's wall or profile; may enable a user to post a message to a group or a fan page; or may enable a user to comment on an image, wall post or other content item created or uploaded by the user or another user. In least one embodiment, a user posts a status message to the user's profile indicating a current event, state of mind, thought, feeling, activity, or any other present-time relevant communication. A social networking system may enable users to communicate both within and external to the social networking system. For example, a first user may send a second user a message within the social networking system, an email through the social networking system, an email external to but originating from the social networking system, an instant message within the social networking system, and an instant message external to but originating from the social networking system. Further, a first user may comment on the profile page of a second user, or may comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection is a social network edge. Being friends in a social networking system may allow users access to more information about each other than would otherwise be available to unconnected users. For example, being friends may allow a user to view another user's profile, to see another user's friends, or to view pictures of another user. Likewise, becoming friends within a social networking system may allow a user greater access to communicate with another user, e.g., by email (internal and external to the social networking system), instant message, text message, phone, or any other communicative interface. Being friends may allow a user access to view, comment on, download, endorse or otherwise interact with another user's uploaded content items. Establishing connections, accessing user information, communicating, and interacting within the context of the social networking system may be represented by an edge between the nodes representing two social networking system users.

In addition to explicitly establishing a connection in the social networking system, users with common characteristics may be considered connected (such as a soft or implicit connection) for the purposes of determining social context for use in determining the topic of communications. In at least one embodiment, users who belong to a common network are considered connected. For example, users who attend a common school, work for a common company, or belong to a common social networking system group may be considered connected. In at least one embodiment, users with common biographical characteristics are considered connected. For example, the geographic region users were born in or live in, the age of users, the gender of users and the relationship status of users may be used to determine whether users are connected. In at least one embodiment, users with common interests are considered connected. For example, users' movie preferences, music preferences, political views, religious views, or any other interest may be used to determine whether users are connected. In at least one embodiment, users who have taken a common action within the social networking system are considered connected. For example, users who endorse or recommend a common object, who comment on a common content item, or who RSVP to a common event may be considered connected. A social networking system may utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

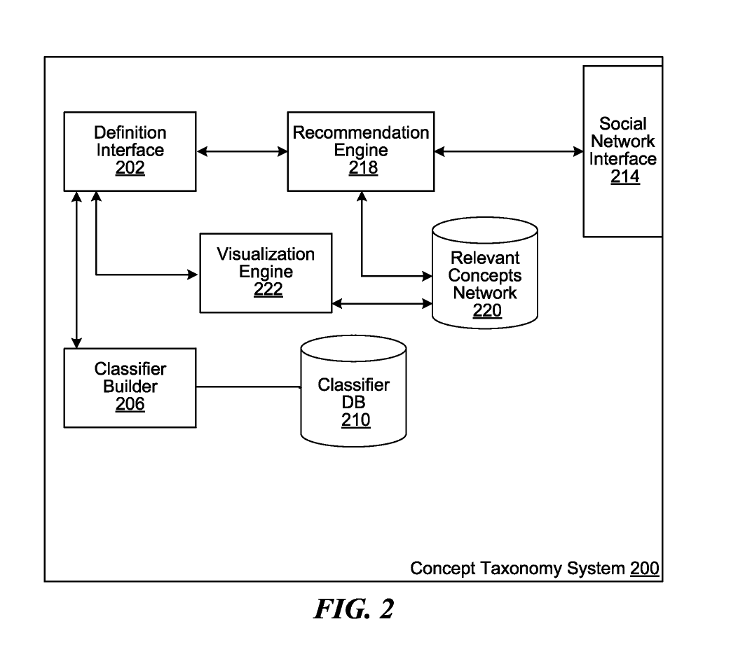

FIG. 2 is a block diagram illustrating a concept taxonomy system 200 (e.g., the concept taxonomy system 118 of FIG. 1), in accordance with various embodiments. The concept taxonomy system 200 may be part of a social networking system (e.g., the application service system 100 of FIG. 1 or the social networking system 902 of FIG. 9). The concept taxonomy system 200 can facilitate generation of a concept taxonomy that serves as a gatekeeper to determine whether a particular user activity is to be aggregated for analysis by a concept analysis engine (e.g., the concept analysis engine 132 of FIG. 1). For example, the concept taxonomy system 200 can include a definition interface engine 202, a classifier builder engine 206, a classifier database 210, a social network interface 214, a recommendation engine 218, a visualization engine 222, or any combination thereof.

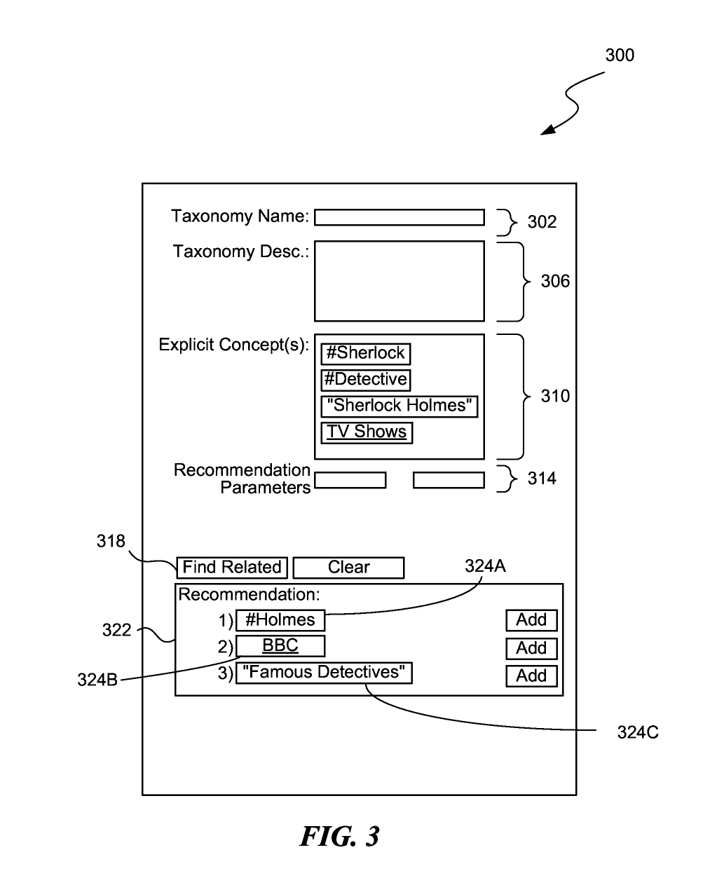

The definition interface engine 202 maintains an interface (e.g., a user interface or an application programming interface (API)) for an analyst user to define a concept taxonomy. For example, the definition interface engine 202 can generate the interface as a webpage accessible to the analyst user. In some embodiments, such webpage is only accessible via a local area network that the concept taxonomy system 200 is part of. In another example, the definition interface engine 202 can maintain an API that enables an external device to generate and render a user interface to define the concept taxonomy. For example, FIG. 3 illustrates a screenshot of a definition interface 300 that may be generated by the definition interface engine 202.

The classifier builder engine 206 can generate a concept taxonomy based on concept nodes identified on the definition interface and generated by the definition interface engine 202. A concept node is associated with a concept identifier. The concept identifier of the concept node can match against one or more identifiers that are part of a unit of content (e.g., as metadata or a portion of the substantive content). For example, a concept identifier can be a topic tag, a social network hashtag, a term object, or any combination thereof.

A topic tag can be a social network object that references a social network page. The topic tag can be associated with a portion of content in one or more ways. In one example, a social networking system can implement a topic inference module that infers topics based on content items in user-generated content. For example, U.S. patent application Ser. No. 13/589,693, entitled “Providing Content Using Inferred Topics Extracted from Communications in a Social Networking System” discloses a way to infer interests based on extracted topics from content items on a social networking system. In another example, an authoring user of a piece of content can associate the topic tag with the piece of content that it creates. In some cases, a user visiting the social network object can make the topic tag. This can occur by an explicit reference to a social networking page in a user post (e.g., a social network “mention”) or an explicit reference in a status update or minutia.

A hash tag is an example of a concept identifier that associates with content based on the authoring user of the content. A hashtag is a word or phrase preceded by a hash or pound sign (“#”) to identify messages relating to a specific topic. The authoring user can insert the hashtag in a piece of content he or she generates. For example, a hashtag can appear in any user-generated content of social media platforms, such as the social networking system 902 of FIG. 9.

A term object is a set of words (e.g., bigrams, trigrams, etc.) that may be tracked by the social networking system. In some embodiments, while the topic tag is associated with a social network page in a social graph of the social networking system, a term object is not part of the social graph. In these embodiments, term objects are tracked once it is explicitly defined in the concept taxonomy system 200 or in preparation of making recommendations of relevant concept nodes by the recommendation engine 218.

The user interface can receive indications of one or more concept identifiers corresponding to one or more explicit concept nodes to associate with a concept taxonomy. In some embodiments, to identify a concept identifier, the user interface can provide a typeahead mechanism. For example, as an analyst user types in one or more characters onto the user interface, the typeahead mechanism can search through the social graph of the social networking system to identify a concept identifier that the characters match or partially match against.

In some cases, a unique text string maps to a single concept identifier. In some cases, a unique text string maps to multiple concept identifiers. In some embodiments, to resolve the case of one-to-multiple mapping of topic tags, the social networking system can implement a system to cluster social network pages having the same or substantially similar title or description and select one of the social network pages and its associated topic tag as the canonical topic tag associated with the title or description. Hence, the typeahead mechanism can present the canonical topic tag on the user interface when the analyst user enters one or more characters that match or partially match the title or description of the cluster of social network pages. For example, U.S. patent application Ser. No. 13/295,000, entitled “Determining a Community Page for a Concept in a Social Networking System” discloses a way for equivalent concepts expressed across multiple domains to be matched and associated with a metapage generated by a social networking system.

The classifier builder engine 206 can store the concept taxonomy it generates in the classifier database 210. In some embodiments, the classifier database 210 can maintain a mapping between a concept study and one or more concept taxonomies. The classifier database 210 can also store a mapping of concept identifiers associated with a concept taxonomy.

In several embodiments, the recommendation engine 218 can generate and suggest relevant concept nodes to an analyst user via the definition interface. The recommendation engine 218 can generate the relevant concept nodes based on the explicit concept nodes of a concept taxonomy. In turn, the analyst user can select one or more of the suggested relevant concept nodes and their associated concept identifiers and add them to the concept taxonomy.

For example, the recommendation engine 218 can identify a pool of potential concept nodes from which to suggest the relevant concept nodes. The pool of potential concept nodes may be extracted from a social graph of the social networking system. Via the definition interface, an analyst user can identify one or more concept source parameters that define how to extract the pool of potential concept nodes from the social graph. In some embodiments, absent user definition, the recommendation engine 218 can use default concept source parameters.

In some embodiments, the concept source parameters include identifying a time window (e.g., past 7 days or past 28 days). The recommendation engine 218 can identify potential concept nodes that share a commonality with one or more of the explicit concept nodes in past user activities within the time window. For example, the recommendation engine 218 can extract the past user activities via the social network interface 214, which enables the recommendation engine 218 to access a social graph or a user activity log of the social networking system. In some embodiments, the concept source parameters include types of commonality to observe. For example, commonality can exist by co-occurrence in user-generated content, co-visitation by the same user, co-approval (e.g., “liking”) by the same user.

The recommendation engine 218 can generate a relevant concepts network 220 based on the pool of potential concept nodes identified in past user activities and/or user-generated content within the time window. In some embodiments, the visualization engine 222 can render the relevant concepts network 220 on the definition interface. The relevant concepts network 220 can include the explicit concept nodes and potential concept nodes sharing a commonality with at least one of the explicit concept nodes. In some embodiments, the concept source parameters include a search distance. For example, the search distance may be set to one degree separation neighbors. That is, the concept recommendations can come from potential candidate nodes that are directly or indirectly connected to the explicit concept nodes in the relevant concepts network 220.

In some embodiments, via the definition interface, the analyst user can identify one or more other recommendation parameters. For example, the recommendation parameters can include a maximum number of relevant concept nodes and/or a maximum number of concept recommendations to list on the definition interface. In some embodiments, an analyst user can define a name and a description for a concept taxonomy.

FIG. 3 is an example screenshot of a definition interface 300 for defining a concept taxonomy, in accordance with various embodiments. The definition interface 300 can include a name input element 302 for an analyst user to configure the name of a concept taxonomy. The definition interface 300 can include a description input element 306 for an analyst user to denote a description text describing a central theme or concept that the analyst user is trying to monitor. In some embodiments, the description text is used to inform other analyst users of the nature of the concept taxonomy. In some embodiments, the description text is used by a search mechanism of a concept study system (e.g., the concept study system 112 of FIG. 1). The search mechanism enables an analyst user to search for existing concept taxonomies using a text query. In some embodiments, the description tags are used by a recommendation engine of a concept taxonomy system (e.g., the concept taxonomy system 200 of FIG. 2) in determining concept recommendations.

The definition interface 300 can include at least an explicit concepts field 310 for an analyst user to specify one or more explicit concept identifiers. In some embodiments, there are multiple explicit concepts fields in the definition interface 300. For example, each explicit concepts field can correspond to a concept type (e.g., a topic tag, a hashtag, or a term object). In some embodiments, the explicit concepts field 310 implements a typeahead mechanism. The typeahead mechanism matches or attempts to match characters typed into the explicit concepts field 310 to the name or description of existing social network objects in a social graph of a social networking system (e.g., the social networking system 902 of FIG. 9).

In some cases, an explicit concept identifier may not correspond to an existing social network object. For example, while a topic tag and/or a hashtag may correspond to a social network object, a term object may not correspond to a social network object. Thus, the typeahead mechanism may be restricted to concept identifiers that correspond to existing social network objects. In some embodiments, the typeahead mechanism matches the characters typed into the explicit concepts field 310 to existing term objects used in other concept taxonomies.

In some embodiments, the definition interface 300 includes one or more recommendation parameter input element 314 to specify one or more recommendation parameters. For example, the recommendation parameters can include a data source parameter, a search distance parameter, a maximum results parameter, or any combination thereof. For example, the data source parameter can enable an analyst user to specify a time window of past user activities to generate a relevant concepts network. For example, the search distance parameter can enable an analyst user to specify a minimum degree of separation between a concept recommendation and at least one of the explicit concept identifiers. For example, the maximum results parameter can enable an analyst user to specify the maximum number of concept recommendations to present on the definition interface 300.

The definition interface 300 can include a recommendation trigger element 318 the causes the definition interface 300 to generate concept recommendations in a recommendation portion 322 of the definition interface 300. The recommendation portion 322 can be one or more windows, one or more lists, one or more tabs, or any combination thereof.

For example, the recommendation portion 322 can include a hashtag recommendation 324A, a topic tag recommendation 324B, and a term object recommendation 324C. In some embodiments, the different types of concept recommendations are separated from each other (e.g., as separate lists, tabs, or windows). In some embodiments, the different types of concept recommendations are presented together.

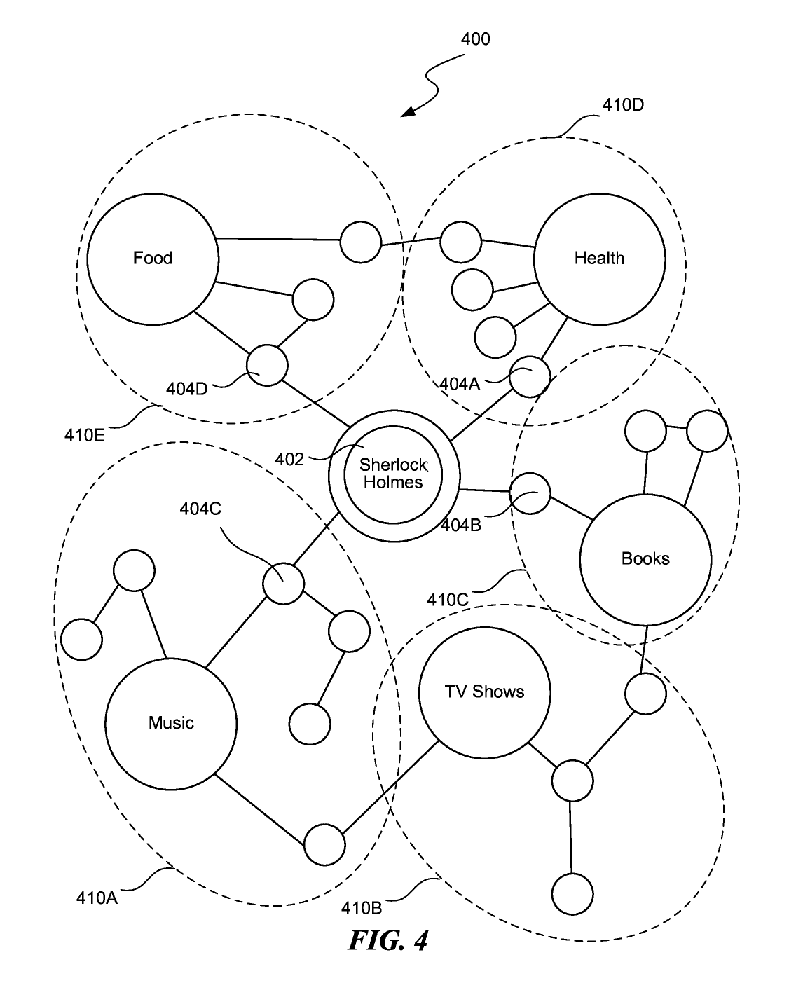

FIG. 4 is an illustration of an example of a relevant concepts network 400, in accordance with various embodiments. In this example, the relevant concepts network 400 includes an explicit concept node 402 associated with an explicit concept identifier of “Sherlock Holmes.” The explicit concept identifier can be a topic tag, a hashtag, or a term object. In this example, the relevant concepts network 400 includes concept nodes that are directly connected to the explicit concept node 402 and those concept nodes that are indirectly connected to the explicit concept node 402. In some embodiments, the relevant concepts network 400 includes concept nodes are not connected, directly or indirectly, to the explicit concept node 402.

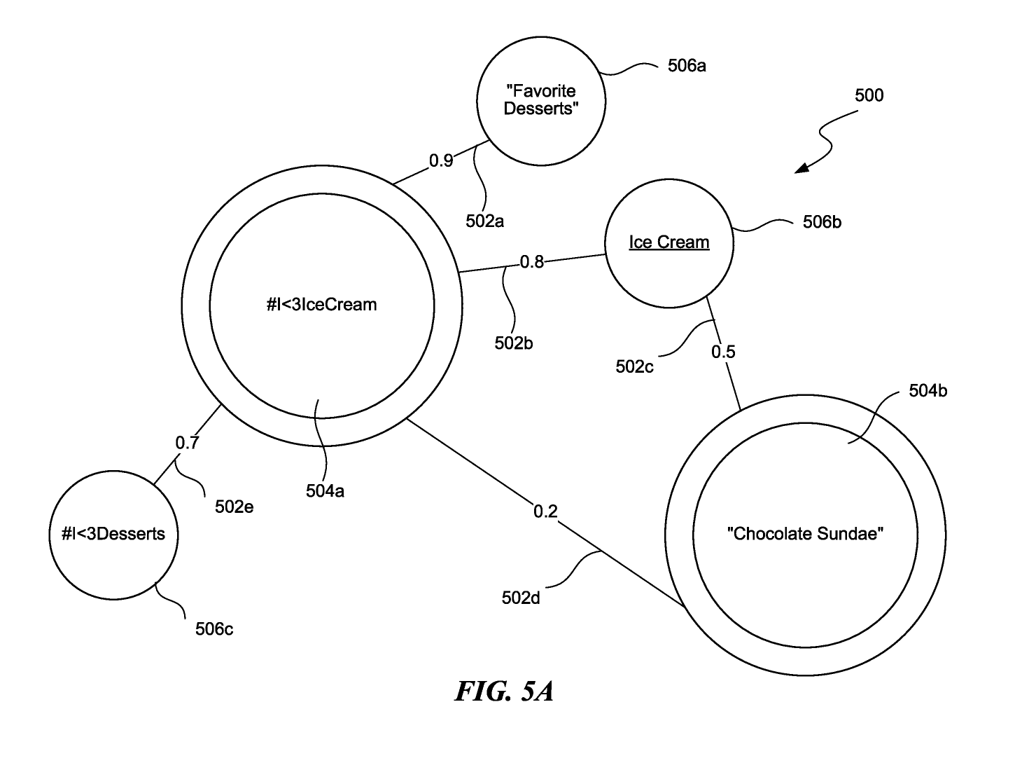

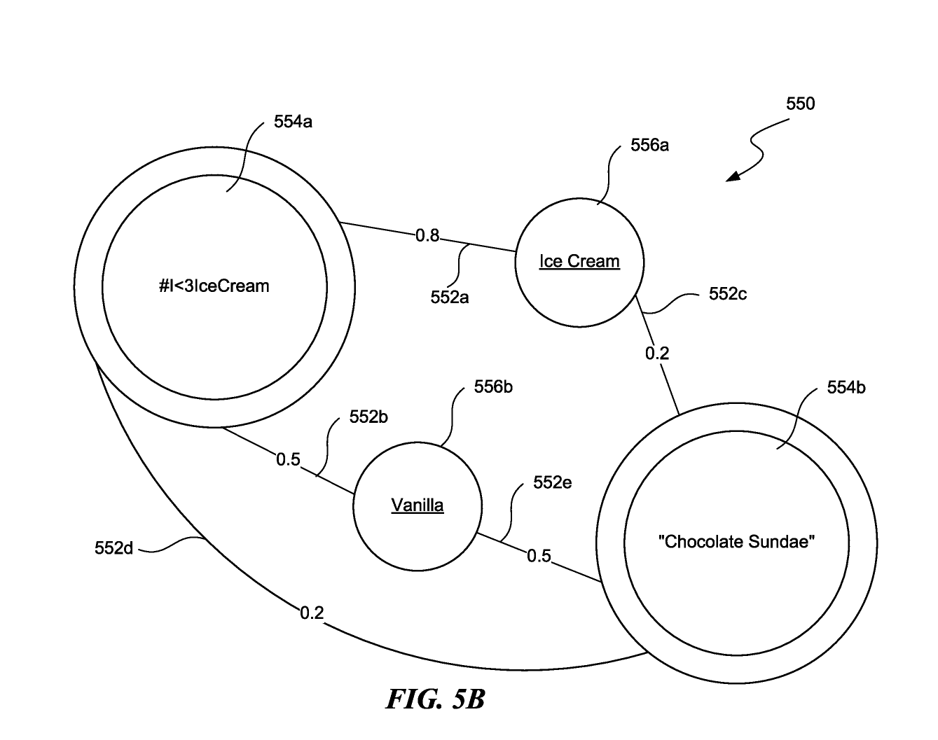

In some embodiments, a recommendation engine of a concept taxonomy system (e.g., the concept taxonomy system 200 of FIG. 2) can make concept recommendations based on the relevant concepts network 400. For example, the recommendation engine can select neighbor nodes 404 (e.g., a neighbor node 404A, a neighbor node 404B, a neighbor node 404C, and a neighbor node 404D, collectively as “the neighbor nodes 404”) of the explicit concept node 402 as the concept recommendations. In some embodiments, the edges of the relevant concepts network are weighted based on the commonality between nodes. In those embodiments, the recommendation engine can utilize those weights in determining a concept recommendation (e.g., see FIGS. 5A and 5B).

In some embodiments, the concept taxonomy system can segment the relevant concepts network into clusters. In some cases, the clusters are mutually exclusive. In some embodiments, the clusters are not mutually exclusive. In this example, the nodes are segmented into a music cluster 410A, a TV show cluster 410B, a box cluster 410C, a health cluster 410D, and a food cluster 410E. In some embodiments, a visualization engine of the concept taxonomy system can render an illustration of the relevant concepts network 400 (e.g., as illustrated by FIG. 4).

FIG. 5A is an example illustration of a portion of a relevant concepts network 500 used to determine one or more concept recommendations, in accordance with various embodiments. In this example, edges (e.g., an edge 502A, an edge 502B, an edge 502C, an edge 502D, and an edge 502E, collectively as “the edges 502”) in the relevant concepts network 500 are weighted by corresponding commonality scores. In some embodiments, and in this example, a higher commonality score denotes that two nodes share more commonality. In some embodiments, a higher score denotes that two nodes share less commonality.

In this example, the edge 502A connects an explicit concept node 504A corresponding to a hashtag “#I<3IceCream” to a potential candidate node 506A corresponding to a term object “Favorite Desserts.” The edge 502A can have a commonality score of 0.9. The edge 502B connects the explicit concept node 504A to a potential candidate node 506B corresponding to a topic tag “Ice Cream.” The edge 502B can have a commonality score of 0.8. The edge 502C connects the potential candidate node 506B to an explicit concept node 504B corresponding to a term object “Chocolate Sundae.” The edge 502C can have a commonality score of 0.5. The edge 502D connects the explicit concept node 504A to the explicit concept node 504B. The edge 502D can have a commonality score of 0.2. The edge 502E connects the explicit concept node 504A to a potential candidate node 506C corresponding to a hashtag “#I<3Desserts.” The edge 502E can have a commonality score of 0.7.

A recommendation engine of a concept taxonomy system (e.g., the concept taxonomy system 200 of FIG. 2) can select one or more of the potential candidate nodes (e.g., the potential candidate node 506A, the potential candidate node 506B, the potential candidate node 506C, collectively as the “the potential candidate nodes 506”) as the concept recommendations. The recommendation engine can deploy one or more criteria in selecting the concept recommendations. For example, a criterion can be a minimum commonality score threshold. In a specific example, the minimum commonality score threshold can be a score of 0.75. In this specific example, the potential candidate node 506A and the potential candidate node 506B can both be selected as the concept recommendations. While the edge 502C only has a commonality score of 0.5, the edge 502B having a commonality score of 0.8 can cause the potential candidate node 506B to be selected.

For another example, a criterion can be a relative commonality threshold. The relative commonality threshold can specify that the concept recommendations correspond to a top set (e.g., top 5 or top 10) of commonality scores amongst all edges. In a specific example, the relative commonality threshold specifies that the concept recommendations will be the top 2 commonality scores. In this specification example, the potential candidate node 506A and the potential candidate node 506B can both be selected as the concept recommendations.

For yet another example, a criterion can be a minimum total commonality threshold. In a specific example, the minimum commonality score threshold can be a score of 1.2. In this specific example, the potential candidate node 506B is the only node that satisfies the criterion to be a concept recommendation. Other potential candidate nodes only have one connection to an explicit concept node, the potential candidate node 506B has both the edge 502B and the edge 502C as connections, and thus the total commonality score is 1.3 (e.g., 0.8+0.5), which is greater than the threshold of 1.2.

FIG. 5B is another example illustration of a portion of a relevant concepts network 550 to determine one or more concept recommendations, in accordance with various embodiments. In this example, edges (e.g., an edge 552A, an edge 552B, an edge 552C, an edge 552D, and an edge 552E, collectively as “the edges 552”) in the relevant concepts network 550 are weighted by corresponding commonality scores.

In this example, the edge 552A connects an explicit concept node 554A corresponding to a hashtag “#I<3IceCream” to a potential candidate node 556A corresponding to a topic tag “Ice Cream.” The edge 552A can have a commonality score of 0.8. The edge 552B connects the explicit concept node 554A to a potential candidate node 556B corresponding to a topic tag “Vanilla.” The edge 552B can have a commonality score of 0.5. The edge 552C connects the potential candidate node 556A to an explicit concept node 554B corresponding to a term object “Chocolate Sundae.” The edge 552C can have a commonality score of 0.2. The edge 552D connects the explicit concept node 554A to the explicit concept node 554B. The edge 552D can have a commonality score of 0.2. The edge 552E connects the explicit concept node 554B to the potential candidate node 556B. The edge 502E can have a commonality score of 0.5.

A recommendation engine of a concept taxonomy system (e.g., the concept taxonomy system 200 of FIG. 2) can select one or more of the potential candidate nodes (e.g., the potential candidate node 556A and the potential candidate node 556B, collectively as the “the potential candidate nodes 556”) as the concept recommendations. The recommendation engine can deploy the criteria as discussed above. The criteria can further be configured to optimize for equally high commonality scores from a potential candidate node to all of the explicit concept nodes. For example, the recommendation engine can implement a criterion for the sum of absolute differences between commonality scores to different explicit concept nodes to be beyond (e.g., less than or more than) a threshold. In one specific example, the criterion specifies that the sum of differences between the commonality scores to the different explicit concept nodes be less than 0.2. Here, the edge 552B and the edge 552E connect the potential candidate node 556B to the explicit concept nodes. The absolute difference between the commonality scores of the edge 552B and the edge 552E is 0 (e.g., 0.5-0.5). The edge 552A and the edge 552C connect the potential candidate node 556A to the explicit concept nodes. The absolute difference between the commonality scores of the edge 552A and the edge 552C is 0.6 (e.g., 0.8-0.2). Accordingly, in this specific example, only the potential candidate node 556B satisfies the criterion. In several embodiments, more than one criteria have to be met in order for the potential candidate node to be selected as a concept recommendation.

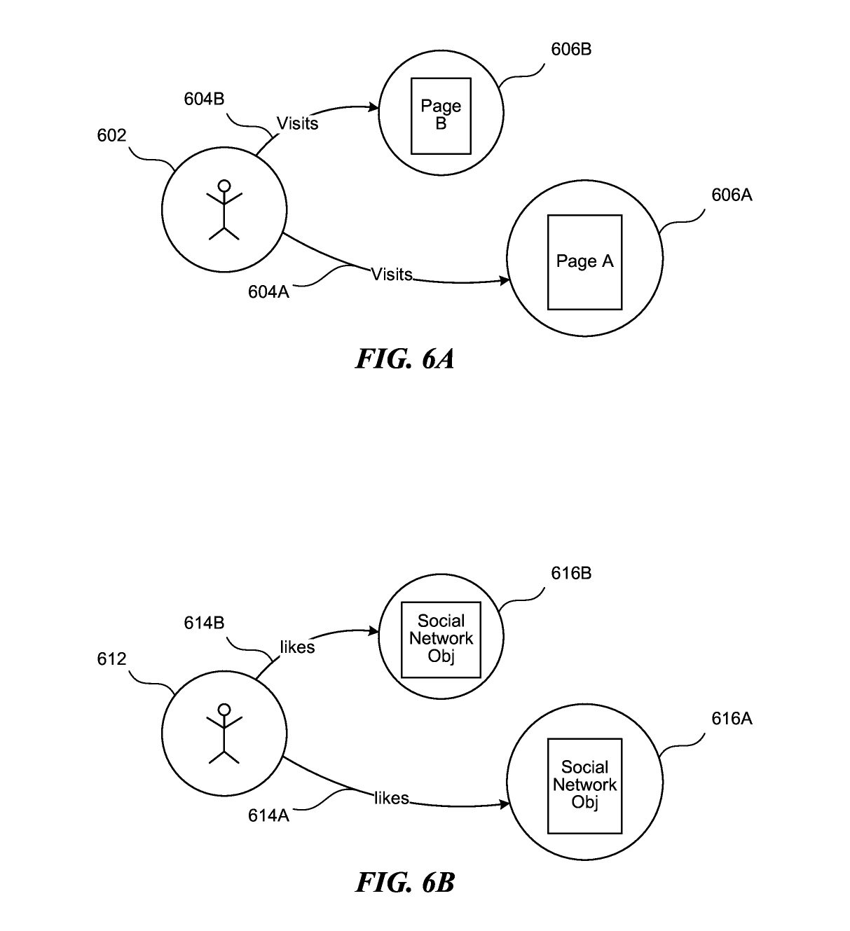

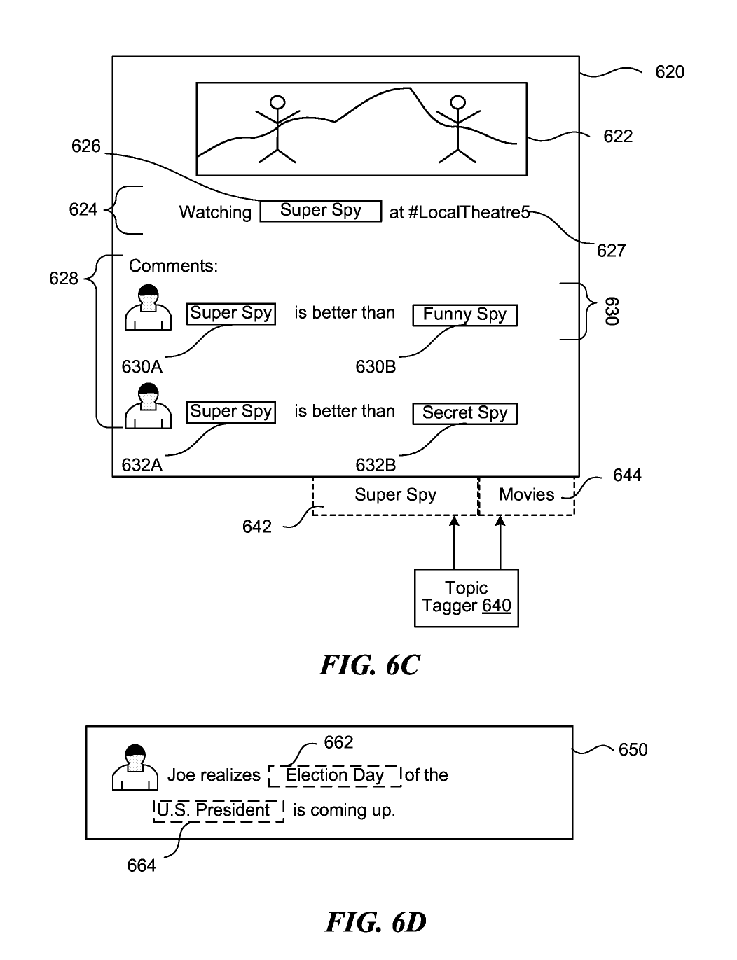

FIG. 6A is an example illustration showing how a co-visitation commonality is established between two concept identifiers, in accordance with various embodiments. In this example, an activity log or a social graph of a social networking system (e.g., the social networking system 902 of FIG. 9) can reflect the activities of a user 602. The activities, for example, can include a page visit 604A to a social network page 606A and a page visit 604B to a social network page 606B. Because the user 602 co-visits both the social network page 606A and the social network page 606B, a concept taxonomy system (e.g., the concept taxonomy system 200 of FIG. 2) can establish an edge/connection between concept identifiers corresponding to the social network pages 606A and 606B in a relevant concepts network.

The commonality score of that connection can be calculated relative to the frequency of co-visitation within a specified time window. For example, the commonality score can be calculated relative to the number of users (e.g., including the user 602) that co-visits the social network pages 606A and 606B in the last 7 days.

FIG. 6B is an example illustration showing how a co-approval commonality is established between two concept identifiers, in accordance with various embodiments. In this example, an activity log or a social graph of a social networking system (e.g., the social networking system 902 of FIG. 9) can reflect the activities of a user 612. The activities, for example, can include an approval action 614A (e.g., a social “like”) to a social network object 616A and an approval action 614B to a social network object 616B. Because the user 612 co-approves both the social network object 616A and the social network object 616B, a concept taxonomy system (e.g., the concept taxonomy system 200 of FIG. 2) can establish an edge/connection between concept identifiers corresponding to the social network object 616A and 616B in a relevant concepts network.

The commonality score of that connection can be calculated relative to the frequency of co-approval within a specified time window. For example, the commonality score can be calculated relative to the number of users (e.g., including the user 612) that co-approves the social network objects 616A and 616B in the last 7 days.

FIG. 6C is an example illustration showing how a co-occurrence commonality is established between two concept identifiers in a social network page 620, in accordance with various embodiments. In this example, a social graph of a social networking system (e.g., the social networking system 902 of FIG. 9) can reflect the contents of the social network page 620. The social network page 620 can include a social network object 622 (e.g., a photograph, a video, or a link). The social network object 622 can correspond to a topic “Super Spy Trailer.” This association can be user-specified or system determined. For example, the correspondence between the social network object 622 and the topic “Super Spy Trailer” may be generated by an image tagger engine that analyzes images to determine what social network object(s) that it may be associated with. The social network page 620 can also include a text description 624, which includes an explicit mention 626 of a topic “Super Spy” and a hashtag 627 of “#LocalTheatre5.”

In some embodiments, the social network page 620 includes a comments section 628. The comments section 628 includes a comment 630 that includes an explicit mention 632A of the topic “Super Spy” and an explicit mention 632B of a topic “Funny Spy.” The comments section 628 can also include a comment 634 that includes an explicit mention 636A of the topic “Super Spy” and an explicit mention 636B of the topic “Secret Spy.” In some embodiments, the social network page 620 can be analyzed by a topic tagger engine 640. The topic tagger engine 640 can assign topic tags (e.g., a topic tag 642 of the topic “Super Spy” and a topic tag 644 of a topic “Movies.”) by analyzing the content of the social network page 620 and/or the visitation activities associated therewith.

In several embodiments, because of the co-occurrence of the various mentions and topic tags, a concept taxonomy system (e.g., the concept taxonomy system 200 of FIG. 2) can establish one or more edges/connections amongst concept identifiers corresponding to the mentioned topics or assigned topics. For example, the concept taxonomy system can create a commonality connection between at least two or any two of the topics “Super Spy,” “Local Theatre 5,” “Funny Spy,” “Movies,” “Super Spy Trailer,” and the “Secret Spy.” The commonality score of that connection can be calculated relative to the frequency of co-occurrence within a batch of social network pages (e.g., social network pages created and/or or visited during a specified time window).

FIG. 6D is an example illustration showing how a co-occurrence commonality is established between two concept identifiers in a status update 650, in accordance with various embodiments. In this example, a social graph of a social networking system (e.g., the social networking system 902 of FIG. 9) can reflect the contents of the status update 650. The status update 650 can be associated with a single user. The status update 650 includes an explicit mention 662 of a topic “Election Day” and an explicit mention 664 of a topic “U.S. President.” Because of the co-occurrence of the explicit mentions, a concept taxonomy system (e.g., the concept taxonomy system 200 of FIG. 2) can establish a connection/edge between concept identifiers corresponding to the mentioned topics. For example, the concept taxonomy system can establish a connection between the “Election Day” concept identifier and the “U.S. President” concept identifier.

In several embodiments, other content of the social networking system may be analyzed to generate a commonalities edge. The data available may be subject to user-specified privacy settings. The user-specified privacy settings can govern whether user-generated content is available to other users and/or application services of the social networking system. For example, the user-specified privacy settings can prevent or allow the concept taxonomy system to access certain user activities (e.g., the status update 650, the social network page 620, the approval action 614A, the approval action 614 B, the page visit 606A, the page visit 606B, other social network objects, or any combination thereof.

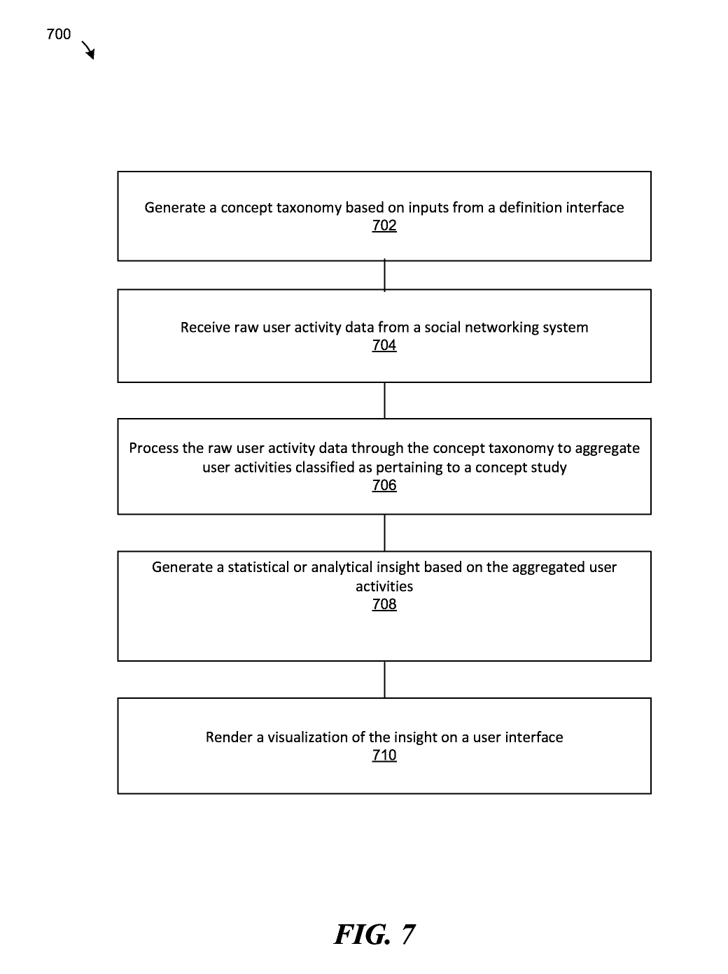

FIG. 7 is a flow chart illustrating a method 700 of operating a concept study system (e.g., the concept study system 112 of FIG. 1), in accordance with various embodiments. The concept study system can be part of a social networking system (e.g., the application service system 100 of FIG. 1 or the social networking system 902 of FIG. 9). The concept study system can implement a concept taxonomy system (e.g., the concept taxonomy system 200 of FIG. 2). At step 702, the concept taxonomy system can generate a concept taxonomy based on inputs from a definition interface. The concept taxonomy can be a mechanism to identify user activities in a social networking system (e.g., the application service system 100 of FIG. 1 or the social networking system 902 of FIG. 9) that is relevant to a concept study. The concept taxonomy can be associated with a concept study of digital chatter in the social networking system.

At step 704, a content filter engine of the concept study system can receive raw user activity data from the social networking system. For example, the raw user activity data can be a text row. At step 706, the content filter engine can process the raw user activity data through the concept taxonomy to aggregate user activities classified as pertaining to the concept study. At step 708, a concept analysis engine of the concept study system can generate a statistical or analytical insight based on the aggregated user activities. At step 710, the concept analysis engine can render a visualization of the insight on a user interface.

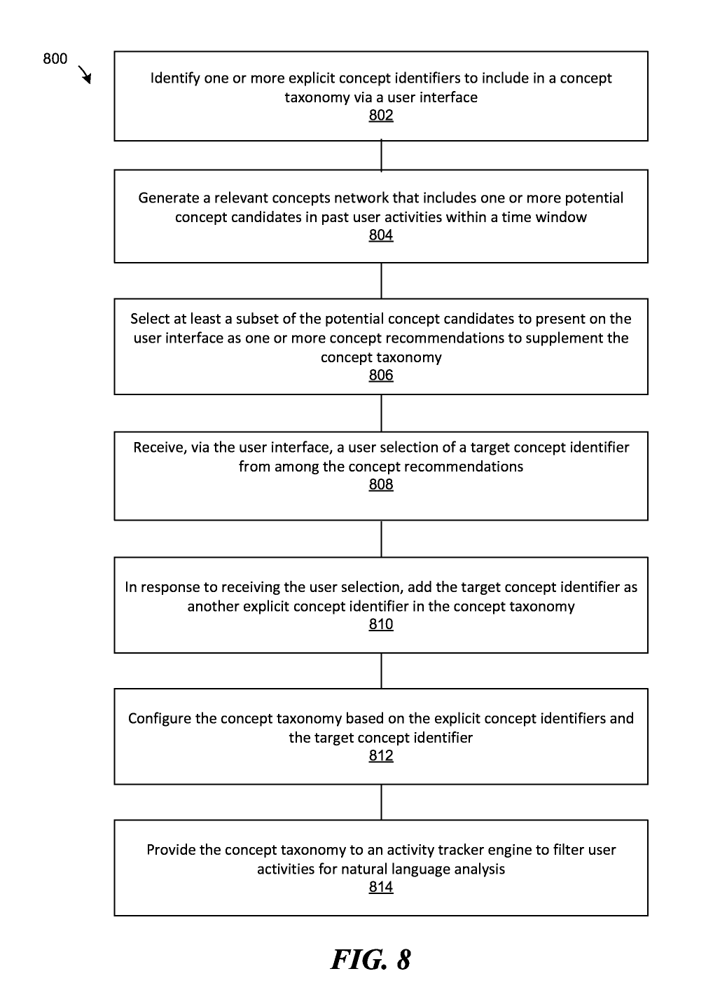

FIG. 8 is a flow chart illustrating a method 800 of operating a concept taxonomy system (e.g., the concept taxonomy system 200 of FIG. 2), in accordance with various embodiments. At step 802, the concept taxonomy system can identify one or more explicit concept identifiers to include in a concept taxonomy via a user interface. The concept taxonomy can be a mechanism to identify user activities in a social networking system (e.g., the application service system 100 of FIG. 1 or the social networking system 902 of FIG. 9) that is relevant to a concept study. The concept taxonomy can be associated with a digital chatter study in the social networking system.

At step 804, the concept taxonomy system can generate a relevant concepts network (e.g., the relevant concepts network 220 of FIG. 2) that includes one or more potential concept candidates in past user activities within a time window. The relevant concepts network can include the potential concept candidates and the explicit concept identifiers as nodes. The potential concept candidates can share commonalities (e.g., directly or indirect) with the explicit concept identifiers. The concept taxonomy system can identify a potential concept candidate that directly shares a commonality with an explicit concept identifier. The concept taxonomy system can also identify a potential concept candidate that indirectly shares a commonality with an explicit concept identifier, where the potential concept candidate shares a direct commonality with another potential concept candidate that shares a direct commonality with the explicit concept identifier.

For example, the commonalities can be co-occurrence, co-visitation, co-approval, or any combination thereof. The size of the relevant concepts network can be configured based on a recommendation configuration specified on the user interface. Some of the potential concept candidates (e.g., topic tags and/or hashtags) may correspond to social network objects in the social networking system. Some of the potential concept candidates (e.g., term objects) do not correspond to social network objects in the social networking system.

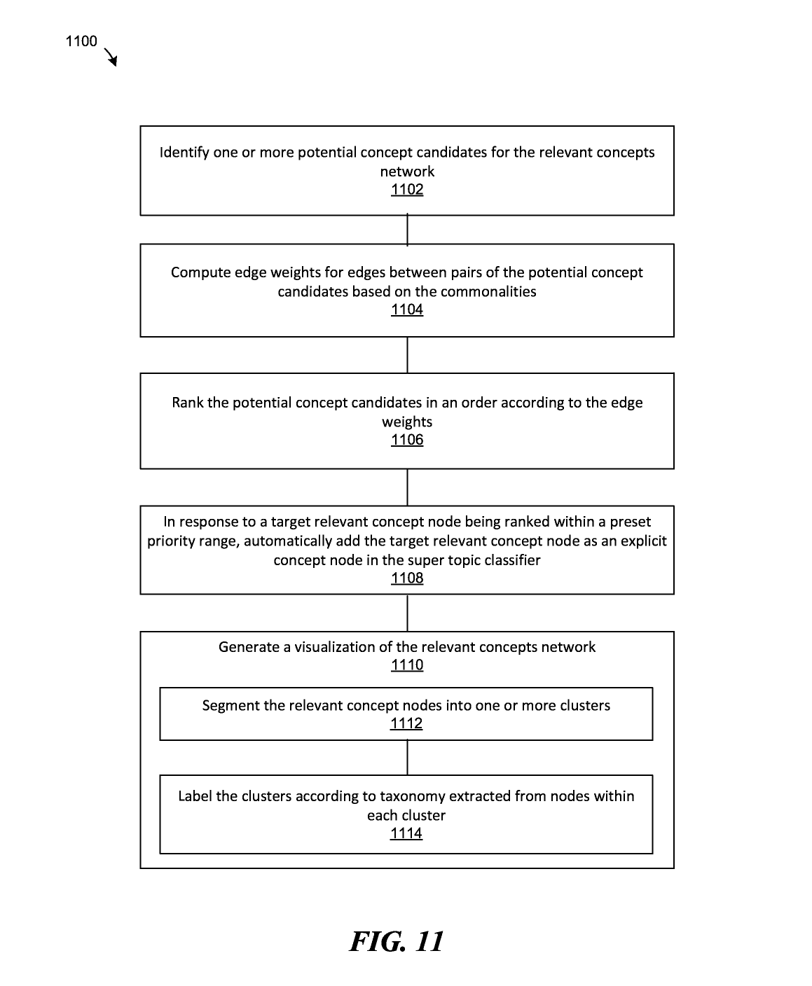

At step 806, the concept taxonomy system can select (e.g., automatically) at least a subset of the potential concept candidates to present on the user interface as one or more concept recommendations to supplement the concept taxonomy. In one example, the concept taxonomy system can select a preset number of the potential concept candidates of a particular type. In one example, the concept taxonomy system can present, on the user interface, the concept recommendations in the subset according to a ranking order (e.g., calculated from step 1104 of FIG. 11). In some embodiments, selecting the subset includes selecting the concept recommendations to present based on a recommendation configuration. The recommendation configuration can include a parameter that specifies concept node types to include in the relevant concepts network. The recommendation configuration can include a parameter that specifies concept node types to include in the concept recommendations. For example, the concept node types can be divided between hashtags, topic tags, and/or term objects. For another example, the recommendation configuration can include a parameter that specifies the network size of the relevant concepts network relative to the explicit concept identifiers (e.g., number of connections to explore from nodes representing the explicit concept identifiers.

At step 808, the concept taxonomy system can receive, via the user interface, a user selection of a target concept identifier from among the concept recommendations. At step 810, in response to receiving the user selection, the concept taxonomy system can add the target concept identifier as another explicit concept identifier in the concept taxonomy. At step 812, the super topic system can configure the concept taxonomy based on the explicit concept identifiers and at least the target concept identifier. At step 814, the super topic system can provide the concept taxonomy to a content filter engine to filter user activities for natural language analysis.

FIG. 11 is a flow chart illustrating a method 1100 of generating a relevant concepts network (e.g., the relevant concepts network 220 of FIG. 2) for a concept taxonomy, in accordance with various embodiments. For example, the method 1100 can correspond to step 804 of FIG. 8. At step 1102, the concept taxonomy system can identify one or more potential concept candidates that share commonalities with each other and/or with explicit concept identifiers already specified in the concept taxonomy. The potential concept candidates can be sourced from past user activities within a time window. The potential concept candidates can be placed into the relevant concepts network.

At step 1104, the concept taxonomy system can compute edge weights for edges between pairs of the potential concept candidates and/or the explicit concept candidates based on the commonalities. At step 1106, the concept taxonomy system can rank the potential concept candidates in an order according to the edge weights.

For example, the concept taxonomy system can rank a target relevant concept node based on a sum of edge weights between the target relevant concept node and every explicit concept identifiers that directly connect to the target relevant concept node. For another example, the concept taxonomy system can rank a target relevant concept node based on a sum of edge weights between the target relevant concept node and every explicit concept identifiers that connect to the target relevant concept node within a preconfigured number of hops. In another example, the concept taxonomy system can rank a target relevant concept node by minimizing or maximizing every edge weight of edges that connect the target relevant concept node to the explicit concept identifiers.

Optionally, at step 1108, in response to the target relevant concept node being ranked within a preset priority range, the concept taxonomy system can automatically add the target relevant concept node as an explicit concept node in the concept taxonomy. In some embodiments, at step 1110, the concept taxonomy system generates a visualization of the relevant concepts network. The visualization can include one or more illustrations corresponding to the concept recommendations and the explicit concept identifiers. In some embodiments, step 1110 includes sub-step 1112 where the concept taxonomy system segments the relevant concept nodes into one or more clusters and sub-step 1114 where the concept taxonomy system labels the clusters according to taxonomy extracted from nodes within each cluster. The labeling can be done on the visualization of the relevant concepts network. The visualization can include one or more representations of the clusters.

While processes or blocks are presented in a given order in this disclosure, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

FIG. 9 is a high-level block diagram of a system environment 900 suitable for a social networking system 902, in accordance with various embodiments. The system environment 900 shown in FIG. 9 includes the social networking system 902 (e.g., the application service system 100 of FIG. 1), a client device 904A, and a network channel 906. The system environment 900 can include other client devices as well, e.g., a client device 904B and a client device 904C. In other embodiments, the system environment 900 may include different and/or additional components than those shown by FIG. 9. The concept taxonomy system 200 of FIG. 2 can be implemented in the social networking system 902.

### Social Networking System Environment and Architecture

The social networking system 902, further described below, comprises one or more computing devices storing user profiles associated with users (i.e., social networking accounts) and/or other objects as well as connections between users and other users and/or objects. Users join the social networking system 902 and then add connections to other users or objects of the social networking system to which they desire to be connected. Users of the social networking system 902 may be individuals or entities, e.g., businesses, organizations, universities, manufacturers, etc. The social networking system 902 enables its users to interact with each other as well as with other objects maintained by the social networking system 902. In some embodiments, the social networking system 902 enables users to interact with third-party websites and a financial account provider.

Based on stored data about users, objects and connections between users and/or objects, the social networking system 902 generates and maintains a “social graph” comprising multiple nodes interconnected by multiple edges. Each node in the social graph represents an object or user that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 902 adds and/or modifies edges connecting the various nodes to reflect the interactions.

The client device 904A is a computing device capable of receiving user input as well as transmitting and/or receiving data via the network channel 906. In at least one embodiment, the client device 904A is a conventional computer system, e.g., a desktop or laptop computer. In another embodiment, the client device 904A may be a device having computer functionality, e.g., a personal digital assistant (PDA), mobile telephone, a tablet, a smart-phone or similar device. In yet another embodiment, the client device 904A can be a virtualized desktop running on a cloud computing service. The client device 904A is configured to communicate with the social networking system 902 via a network channel 906 (e.g., an intranet or the Internet). In at least one embodiment, the client device 904A executes an application enabling a user of the client device 904A to interact with the social networking system 902. For example, the client device 904A executes a browser application to enable interaction between the client device 904A and the social networking system 902 via the network channel 906. In another embodiment, the client device 904A interacts with the social networking system 902 through an application programming interface (API) that runs on the native operating system of the client device 904A, e.g., IOS® or ANDROID™.

The client device 904A is configured to communicate via the network channel 906, which may comprise any combination of local area and/or wide area networks, using both wired and wireless communication systems. In at least one embodiment, the network channel 906 uses standard communications technologies and/or protocols. Thus, the network channel 906 may include links using technologies, e.g., Ethernet, 802.11, worldwide interoperability for microwave access (WiMAX), 3G, 4G, CDMA, digital subscriber line (DSL), etc. Similarly, the networking protocols used on the network channel 906 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network channel 906 may be represented using technologies and/or formats including hypertext markup language (HTML) or extensible markup language (XML). In addition, all or some of links can be encrypted using conventional encryption technologies, e.g., secure sockets layer (SSL), transport layer security (TLS), and Internet Protocol security (IPsec).

The social networking system 902 includes a profile store 910, a content store 912, an action logger 914, an action log 916, an edge store 918, an concept taxonomy system 922, a web server 924, a message server 926, an application service interface (API) request server 928, a concept study system 932, or any combination thereof. In other embodiments, the social networking system 902 may include additional, fewer, or different modules for various applications.

User of the social networking system 902 can be associated with a user profile, which is stored in the profile store 910. The user profile is associated with a social networking account. A user profile includes declarative information about the user that was explicitly shared by the user, and may include profile information inferred by the social networking system 902. In some embodiments, a user profile includes multiple data fields, each data field describing one or more attributes of the corresponding user of the social networking system 902. The user profile information stored in the profile store 910 describes the users of the social networking system 902, including biographic, demographic, and other types of descriptive information, e.g., work experience, educational history, gender, hobbies or preferences, location and the like. A user profile may also store other information provided by the user, for example, images or videos. In some embodiments, images of users may be tagged with identification information of users of the social networking system 902 displayed in an image. A user profile in the profile store 910 may also maintain references to actions by the corresponding user performed on content items (e.g., items in the content store 912) and stored in the edge store 918 or the action log 916.

A user profile may be associated with one or more financial accounts, enabling the user profile to include data retrieved from or derived from a financial account. In some embodiments, information from the financial account is stored in the profile store 910. In other embodiments, it may be stored in an external store.

A user may specify one or more privacy settings, which are stored in the user profile, that limit information shared through the social networking system 902. For example, a privacy setting limits access to cache appliances associated with users of the social networking system 902.

The content store 912 stores content items (e.g., images, videos, or audio files) associated with a user profile. The content store 912 can also store references to content items that are stored in an external storage or external system. Content items from the content store 912 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system or to increase interaction with the social networking system by displaying content related to users, objects, activities, or functionalities of the social networking system 902. Examples of social networking content items include suggested connections or suggestions to perform other actions, media provided to, or maintained by, the social networking system 902 (e.g., pictures or videos), status messages or links posted by users to the social networking system, events, groups, pages (e.g., representing an organization or commercial entity), and any other content provided by, or accessible via, the social networking system.

The content store 912 also includes one or more pages associated with entities having user profiles in the profile store 910. An entity can be a non-individual user of the social networking system 902, e.g., a business, a vendor, an organization, or a university. A page includes content associated with an entity and instructions for presenting the content to a social networking system user. For example, a page identifies content associated with the entity's user profile as well as information describing how to present the content to users viewing the brand page. Vendors may be associated with pages in the content store 912, enabling social networking system users to more easily interact with the vendor via the social networking system 902. A vendor identifier is associated with a vendor's page, thereby enabling the social networking system 902 to identify the vendor and/or to retrieve additional information about the vendor from the profile store 910, the action log 916 or from any other suitable source using the vendor identifier. In some embodiments, the content store 912 may also store one or more targeting criteria associated with stored objects and identifying one or more characteristics of a user to which the object is eligible to be presented.

The action logger 914 receives communications about user actions on and/or off the social networking system 902, populating the action log 916 with information about user actions. Such actions may include, for example, adding a connection to another user, sending a message to another user, uploading an image, reading a message from another user, viewing content associated with another user, attending an event posted by another user, among others. In some embodiments, the action logger 914 receives, subject to one or more privacy settings, content interaction activities associated with a user. In addition, a number of actions described in connection with other objects are directed at particular users, so these actions are associated with those users as well. These actions are stored in the action log 916.

In accordance with various embodiments, the action logger 914 is capable of receiving communications from the web server 924 about user actions on and/or off the social networking system 902. The action logger 914 populates the action log 916 with information about user actions. This information may be subject to privacy settings associated with the user. Any action that a particular user takes with respect to another user is associated with each user's profile, through information maintained in a database or other data repository, e.g., the action log 916. Such actions may include, for example, adding a connection to the other user, sending a message to the other user, reading a message from the other user, viewing content associated with the other user, attending an event posted by another user, being tagged in photos with another user, liking an entity, etc.

The action log 916 may be used by the social networking system 902 to record user actions on the social networking system 902, as well as external website that communicate information to the social networking system 902. Users may interact with various objects on the social networking system 902, including commenting on posts, sharing links, and checking-in to physical locations via a mobile device, accessing content items in a sequence or other interactions. Information describing these actions is stored in the action log 916. Additional examples of interactions with objects on the social networking system 902 included in the action log 916 include commenting on a photo album, communications between users, becoming a fan of a musician, adding an event to a calendar, joining a groups, becoming a fan of a brand page, creating an event, authorizing an application, using an application and engaging in a transaction. Additionally, the action log 916 records a user's interactions with advertisements on the social networking system 902 as well as applications operating on the social networking system 902. In some embodiments, data from the action log 916 is used to infer interests or preferences of the user, augmenting the interests included in the user profile, and enabling a more complete understanding of user preferences.

Further, user actions that happened in particular context, e.g., when the user was shown or was seen accessing particular content on the social networking system 902, can be captured along with the particular context and logged. For example, a particular user could be shown/not-shown information regarding candidate users every time the particular user accessed the social networking system 902 for a fixed period of time. Any actions taken by the user during this period of time are logged along with the context information (i.e., candidate users were provided/not provided to the particular user) and are recorded in the action log 916. In addition, a number of actions described below in connection with other objects are directed at particular users, so these actions are associated with those users as well.

The action log 916 may also store user actions taken on external websites services associated with the user. The action log 916 records data about these users, including viewing histories, advertisements that were engaged, purchases or rentals made, and other patterns from content requests and/or content interactions.

In some embodiments, the edge store 918 stores the information describing connections between users and other objects on the social networking system 902 in edge objects. The edge store 918 can store the social graph described above. Some edges may be defined by users, enabling users to specify their relationships with other users. For example, users may generate edges with other users that parallel the users' real-life relationships, e.g., friends, co-workers, partners, and so forth. Other edges are generated when users interact with objects in the social networking system 902, e.g., expressing interest in a page or a content item on the social networking system, sharing a link with other users of the social networking system, and commenting on posts made by other users of the social networking system. The edge store 918 stores edge objects that include information about the edge, e.g., affinity scores for objects, interests, and other users. Affinity scores may be computed by the social networking system 902 over time to approximate a user's affinity for an object, interest, and other users in the social networking system 902 based on the actions performed by the user. Multiple interactions of the same type between a user and a specific object may be stored in one edge object in the edge store 918, in at least one embodiment. In some embodiments, connections between users may be stored in the profile store 910. In some embodiments, the profile store 910 may reference or be referenced by the edge store 918 to determine connections between users. Users may select from predefined types of connections, or define their own connection types as needed.

The web server 924 links the social networking system 902 via a network to one or more client devices; the web server 924 serves web pages, as well as other web-related content, e.g., Java, Flash, XML, and so forth. The web server 924 may communicate with the message server 926 that provides the functionality of receiving and routing messages between the social networking system 902 and client devices. The messages processed by the message server 926 can be instant messages, email messages, text and SMS (short message service) messages, photos, or any other suitable messaging technique. In some embodiments, a message sent by a user to another user can be viewed by other users of the social networking system 902, for example, by the connections of the user receiving the message. An example of a type of message that can be viewed by other users of the social networking system besides the recipient of the message is a wall post. In some embodiments, a user can send a private message to another user that can only be retrieved by the other user.

The API request server 928 enables external systems to access information from the social networking system 902 by calling APIs. The information provided by the social network may include user profile information or the connection information of users as determined by their individual privacy settings. For example, a system interested in predicting the probability of users forming a connection within a social networking system may send an API request to the social networking system 902 via a network. The API request server 928 of the social networking system 902 receives the API request. The API request server 928 processes the request by determining the appropriate response, which is then communicated back to the requesting system via a network.

The concept study system 932 can be the concept study system 112 of FIG. 1. The concept taxonomy system 922 can be the concept taxonomy system 200 of FIG. 2. The concept taxonomy system 200 of FIG. 2. The concept study system 932 can enable analyst users to define, modify, monitor, execute, compare, analyze, evaluate, and/or deploy one or more concept studies associated with one or more concept taxonomies. The concept taxonomies can be generated by the concept taxonomy system 922. A concept taxonomy is a way to classify user activities (e.g., recorded by the action logger 914) in the social networking system 902. A content filter engine in the concept study system 932 can aggregate user activities classified by a concept taxonomy. A concept analysis engine of the concept study system 932 can then analyze the aggregate activities to produce statistical or analytical insights based on machine intelligence.

Functional components (e.g., circuits, devices, engines, modules, and data storages, etc.) associated with the application service system 100 of FIG. 1, the concept taxonomy system 200 of FIG. 2, and/or the social networking system 902 of FIG. 9, can be implemented as a combination of circuitry, firmware, software, or other functional instructions. For example, the functional components can be implemented in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). The systems, engines, or devices described may include additional, fewer, or different functional components for various applications.

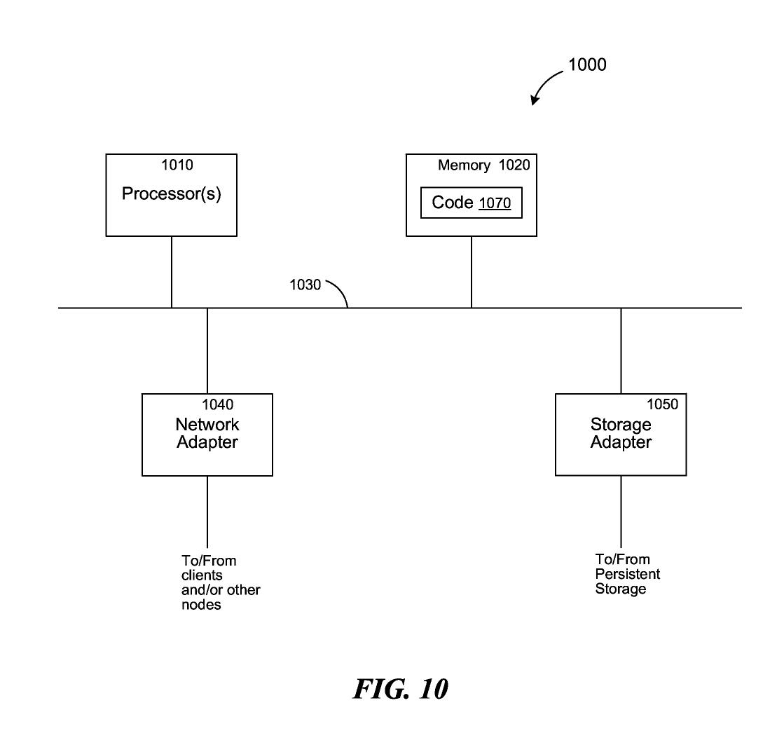

FIG. 10 is a block diagram of an example of a computing device 1000, which may represent one or more computing device or server described herein, in accordance with various embodiments. The computing device 1000 can be one or more computing devices that implement the application service system 100 of FIG. 1 and/or the concept taxonomy system 200 of FIG. 2. The computing device 1000 can execute at least part of the method 700 of FIG. 7, the method 800 of FIG. 8, the method 1100 of FIG. 11, or any combination thereof. The computing device 1000 includes one or more processors 1010 and memory 1020 coupled to an interconnect 1030. The interconnect 1030 shown in FIG. 10 is an abstraction that represents any one or more separate physical buses, point-to-point connections, or both connected by appropriate bridges, adapters, or controllers. The interconnect 1030, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 1010 is/are the central processing unit (CPU) of the computing device 1000 and thus controls the overall operation of the computing device 1000. In certain embodiments, the processor(s) 1010 accomplishes this by executing software or firmware stored in memory 1020. The processor(s) 1010 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 1020 is or includes the main memory of the computing device 1000. The memory 1020 represents any form of random access memory (RAM), read-only memory (ROM), flash memory, or the like, or a combination of such devices. In use, the memory 1020 may contain a code 1070 containing instructions according to the mesh connection system disclosed herein.

Also connected to the processor(s) 1010 through the interconnect 1030 are a network adapter 1040 and a storage adapter 1050. The network adapter 1040 provides the computing device 1000 with the ability to communicate with remote devices, over a network and may be, for example, an Ethernet adapter or Fibre Channel adapter. The network adapter 1040 may also provide the computing device 1000 with the ability to communicate with other computers. The storage adapter 1050 enables the computing device 1000 to access a persistent storage, and may be, for example, a Fibre Channel adapter or SCSI adapter.

The code 1070 stored in memory 1020 may be implemented as software and/or firmware to program the processor(s) 1010 to carry out actions described above. In certain embodiments, such software or firmware may be initially provided to the computing device 1000 by downloading it from a remote system through the computing device 1000 (e.g., via network adapter 1040).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; and/or optical storage media; flash memory devices), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification. Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments. Reference in this specification to where a result of an action is “based on” another element or feature means that the result produced by the action can change depending at least on the nature of the other element or feature.

What is claimed is:

1. A computer-implemented method, comprising:
receiving, via a user interface, one or more explicit concept identifiers to include in a concept taxonomy, wherein the concept taxonomy is a mechanism to identify one or more user activities that are relevant to a content analysis study;
generating a relevant concepts network by identifying one or more potential concept candidates in past user activities constrained within a time window, wherein the relevant concepts network includes, as nodes, the potential concept candidates and the explicit concept identifiers;
selecting at least a subset of the potential concept candidates to display on the user interface as one or more concept recommendations to supplement the concept taxonomy by identifying commonalities between the nodes of the relevant concepts network; and
providing the concept taxonomy to an application service system to filter user activities for the content analysis study.

2. The computer-implemented method of claim 1, wherein identifying the potential concept candidates includes identifying a potential concept candidate that directly shares a commonality with an explicit concept identifier or indirectly shares a commonality with an explicit concept identifier.

3. The computer-implemented method of claim 1, wherein the application service system is a social networking system.

4. The computer-implemented method of claim 1, wherein generating the relevant concepts network includes:
computing edge weights for edges in the relevant concepts network based on the commonalities between the nodes; and
ranking the potential concept candidates in an order according to the edge weights connecting the potential concept candidates to or toward the explicit concept identifiers.

5. The computer-implemented method of claim 4, wherein ranking the potential concept candidates includes ranking a target relevant concept node based on a sum of edge weights between the target relevant concept node to every explicit concept identifiers that directly connect to the target relevant concept node.

6. The computer-implemented method of claim 4, wherein ranking the potential concept candidates includes ranking a target relevant concept node based on a sum of edge weights between the target relevant concept node to every explicit concept identifiers that connect to the target relevant concept node within a preconfigured number of hops.

7. The computer-implemented method of claim 4, wherein ranking the potential concept candidates includes ranking a target relevant concept node by minimizing or maximizing every edge weight of edges that connect the target relevant concept node to the explicit concept identifiers.

8. The computer-implemented method of claim 4, wherein ranking the potential concept candidates includes ranking a target relevant concept node at least by optimizing for a target relevant concept node to minimize differences between commonality scores to the explicit concept identifiers.

9. The computer-implemented method of claim 4, further comprising displaying, on the user interface, the concept recommendations in the subset according to the order from said ranking.

10. The computer-implemented method of claim 4, further comprising in response to a target relevant concept node being ranked within a preset priority range, automatically adding the target relevant concept node as an explicit concept node in the concept taxonomy.

11. The computer-implemented method of claim 1, further comprising displaying a preset number of the potential concept candidates of a particular type.

12. The computer-implemented method of claim 1, further comprising generating a visualization of the relevant concepts network.

13. The computer-implemented method of claim 12, further comprising:
segmenting the nodes in the relevant concepts network into one or more clusters; and
labeling the clusters;
wherein the visualization includes one or more representations of the clusters.

14. The computer-implemented method of claim 1, further comprising:
receiving, via the user interface, a user selection of a target concept identifier from among the concept recommendations; and
in response to receiving the user selection, adding the target concept identifier as another explicit concept identifier in the concept taxonomy.

15. The computer-implemented method of claim 1, further comprising: selecting the concept recommendations to display based on a user configuration of a number of recommendations, one or more types of concept identifiers, a minimum commonality criterion, or any combination thereof.

16. The computer-implemented method of claim 1, wherein the explicit concept identifiers include a hashtag, a topic tag, a term object comprising two or more words, or any combination thereof.

17. A computer readable data storage memory storing computer-executable instructions that, when executed by a computer system, cause the computer system to perform a computer-implemented method, the instructions comprising:
instructions for receiving, via a user interface, one or more explicit concept identifiers to include in a concept taxonomy;
instructions for generating a relevant concepts network by identifying one or more potential concept candidates in past user activities constrained within a time window, wherein the relevant concepts network includes, as nodes, the potential concept candidates and the explicit concept identifiers;
instructions for displaying at least a subset of the potential concept candidates on the user interface as concept recommendations to supplement the concept taxonomy; and
instructions for receiving a user selection of a target relevant concept node; and
instructions for adding the target relevant concept node as an explicit concept identifier of the concept taxonomy, in response to receiving the user selection.

18. The computer readable data storage memory of claim 17, wherein the instructions further comprises:
instructions for identifying a commonality between a potential concept identifier and an explicit concept node by counting a number of times the potential concept identifier co-exists with the explicit concept node in a unit of user-generated content in a social networking system.

19. The computer readable data storage memory of claim 17, wherein the instructions further comprises:
instructions for identifying a commonality between nodes in the relevant concepts network by counting a number of times social network objects corresponding to the nodes are tagged by, visited by, or associated with the same user in a social networking system.

20. A social networking system, comprising:
a definition user interface to define a concept taxonomy by at least receiving one or more explicit concept identifiers inputted thereon;
a recommendation engine configured to generate a relevant concepts network by identifying one or more potential concept candidates in past user activities constrained within a time window, wherein the relevant concepts network includes, as nodes, the potential concept candidates and the explicit concept identifiers;
wherein the recommendation engine is configured to select at least a subset of the potential concept candidates to display on the user interface as concept recommendations to supplement the concept taxonomy by identifying commonalities between the nodes of the relevant concepts network; and
a concept filter engine configured to identify activity traffic coming into the social network system that is associated with the concept taxonomy.
